(19) United States
(12) Patent Application Publication
(10) Pub. No.: US 2025/0367670 A1
(43) Pub. Date: Dec. 4, 2025

(54) Systems and Methods for a Bench System to Support a Mass Spectrometer

(71) Applicant: CMP Scientific Corp, Brooklyn, NY (US)

(72) Inventors: Paul Nurmi, Gardnerville, NV (US); Joshua Wiley, Hillsborough, NC (US); Qiangwei Xia, Brooklyn, NY (US)

(73) Assignee: CMP Scientific Corp, Brooklyn, NY (US)

(21) Appl. No.: 18/731,322

(22) Filed: Jun. 2, 2024

(51) Int. Cl. B01L 9/02; F04B 53/00; H01J 49/00; H01J 49/24

(52) U.S. Cl. CPC B01L 9/02; H01J 49/0022; H01J 49/24; B01L 2400/049; F04B 53/003

(57) ABSTRACT

The disclosed systems and methods pertain to mass spectrometry. A system may include a bench for supporting a mass spectrometer, a pump assembly, and a lift mechanism. The lift mechanism moves the pump assembly between a first state, where the pump assembly rests on the floor isolating the mass spectrometer from pump-induced vibrations, and a second state, where the pump assembly is lifted off the floor enabling the bench system to be moved.

### TECHNICAL FIELD

Various aspects of the present disclosure relate generally to systems and methods for analyzing samples and, more particularly, to systems and methods for a bench system to support a mass spectrometer.

### BACKGROUND

Mass spectrometers are analytical instruments used to identify the amount and type of chemicals present in a sample by measuring the mass-to-charge ratio and abundance of gas-phase ions. These instruments are widely used in various fields such as chemistry, physics, biology, and environmental science.

A mass spectrometer typically includes a sample introduction system, an ion source, a mass analyzer, and a detector. The sample introduction system introduces the sample into the ion source where it is ionized. The ions are then separated based on their mass-to-charge ratio in the mass analyzer and detected by the detector. The resulting data is processed and presented as a mass spectrum.

In many mass spectrometry systems, a roughing pump is used to create a vacuum environment for the ionization and analysis of the sample. The roughing pump removes air and other gases from the mass spectrometer to a low enough pressure so that a turbomolecular pump can operate, which creates a vacuum level to prevent the ions from colliding with gas molecules, which could affect the accuracy of the mass spectrometry analysis.

However, roughing pumps can generate substantial vibrations during operation. These vibrations can be transmitted to the mass spectrometer, potentially affecting the performance of the instrument. For example, the vibrations can cause mechanical instability in the mass spectrometer, leading to inaccuracies in the mass-to-charge ratio measurements.

To mitigate the impact of these vibrations, various methods have been employed to isolate the roughing pump from the mass spectrometer. One such method involves using a shock-like suspension system to support the roughing pump. This system absorbs the vibrations generated by the roughing pump, reducing the amount of vibrational energy that is transmitted to the mass spectrometer.

In addition to vibration isolation, it is also desirable to have a system that allows for easy movement and maintenance of the mass spectrometer and the roughing pump. Furthermore, the roughing pump may require regular maintenance or replacement, so it is beneficial to have a system that allows for easy access to the pump.

The present disclosure is directed to overcoming one or more of these above-referenced challenges.

### SUMMARY OF THE DISCLOSURE

According to certain aspects of the disclosure, systems and methods are disclosed for a bench system to support a mass spectrometer.

In some cases, a bench system may include: a bench configured to support a mass spectrometer; a pump assembly configured to support a pump, wherein the pump assembly has legs and feet for resting on a floor; and a lift mechanism, wherein the lift mechanism is configured to move the pump assembly between a first state and a second state, wherein, in the first state, the pump assembly is at rest on a floor, thereby isolating the mass spectrometer from vibrations caused by the pump when the pump is in operation, and, in the second state, the pump assembly is moved off the floor, thereby enabling the bench system to be moved.

In some cases, a method for isolating a mass spectrometer from vibrations caused by a pump may include: providing a bench system to support a mass spectrometer, wherein the bench system includes: a bench for supporting the mass spectrometer, a pump assembly for supporting a pump, and a lift mechanism, and the lift mechanism is configured to move the pump assembly between a first state and a second state; resting, in the first state, the pump assembly on a floor, thereby isolating the mass spectrometer from vibrations caused by the pump when the pump and the mass spectrometer are in use; moving, by the lift mechanism, the pump assembly from the first state to the second state, thereby enabling the bench system to be moved; moving, by the lift mechanism, the pump assembly from the second state to the first state.

Additional objects and advantages of the disclosed technology will be set forth in part in the description that follows, and in part will be apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1 shows a schematic diagram of an exemplary mass spectrometer.

FIG. 2 shows a perspective view of certain components of a mass spectrometer.

FIG. 3 shows an exemplary particle guide.

FIGS. 4A and 4B show additional views of the particle guide shown in FIG. 3.

FIG. 5 shows a longitudinal cross-sectional view of the particle guide shown in FIG. 3.

FIGS. 6A-6C show exemplary skimmer arrangements for receiving ions.

FIG. 7 shows a perspective view of an exemplary skimmer.

FIG. 8 shows an exemplary method for analyzing a sample.

FIG. 9 depicts a bench system in a first state, supporting a mass spectrometer and a pump assembly, according to aspects of the present disclosure.

FIG. 10 depicts the bench system in a second state, with the pump assembly lifted off the floor, according to aspects of the present disclosure.

FIG. 11A depicts a first view of a bench system according to aspects of the present disclosure.

FIG. 11B depicts a second view of the bench system of FIG. 11A.

FIG. 11C depicts a third view of the bench system of FIG. 11A.

FIG. 11D depicts a fourth view of the bench system of FIG. 11A.

FIG. 12 depicts a flowchart of a method for isolating vibrations in a bench system, according to aspects of the present disclosure.

### DETAILED DESCRIPTION

The present disclosure relates to the field of mass spectrometry, and more particularly, to a bench system to support a mass spectrometer.

The present disclosure relates to a bench system designed to support a mass spectrometer and a pump assembly. In some aspects, the bench system may include a lift mechanism that can move the pump assembly between two states. The pump assembly, in some cases, may be configured with legs and feet that allow it to rest on a floor.

In one state, the pump assembly may rest on the floor, thereby isolating the mass spectrometer from vibrations caused by the pump when the pump is in operation. This isolation may help to prevent a range of issues that could affect the performance of the mass spectrometer. In another state, the pump assembly may be lifted off the floor, enabling the bench system to be moved. This flexibility may provide convenience and efficiency in various operational settings.

The lift mechanism, in some cases, may include a jack screw gear box, an electrical linear actuator, or a mechanical lifting lever. The lift mechanism may be driven manually or electronically by a motor, providing a range of options for operation. In some aspects, the lift mechanism may include a load shaft and a load shaft flange, and the pump assembly may include L-brackets positioned to allow the load shaft flange to lift the pump assembly when the load shaft is raised.

In some cases, the pump assembly may include a drawer and rail system configured to slide the pump in and out for maintenance and/or removal. This feature may provide ease of access for maintenance or replacement of the pump, potentially increasing the longevity and reliability of the bench system.

Moreover, the lift mechanism may include different structures or means of moving the pump assembly. For example, instead of L-brackets, the pump assembly could have a cylinder with a counter bore that allows it to be lifted. Alternatively, the load shaft flange could have holes in it and the pump assembly could have shoulder screws that allow it to be lifted. In another variation, the jack could be connected to a cable that connects to the pump assembly and allows it to be lifted. These modifications may provide additional flexibility and adaptability in different operational contexts.

### 1. Mass Spectrometry

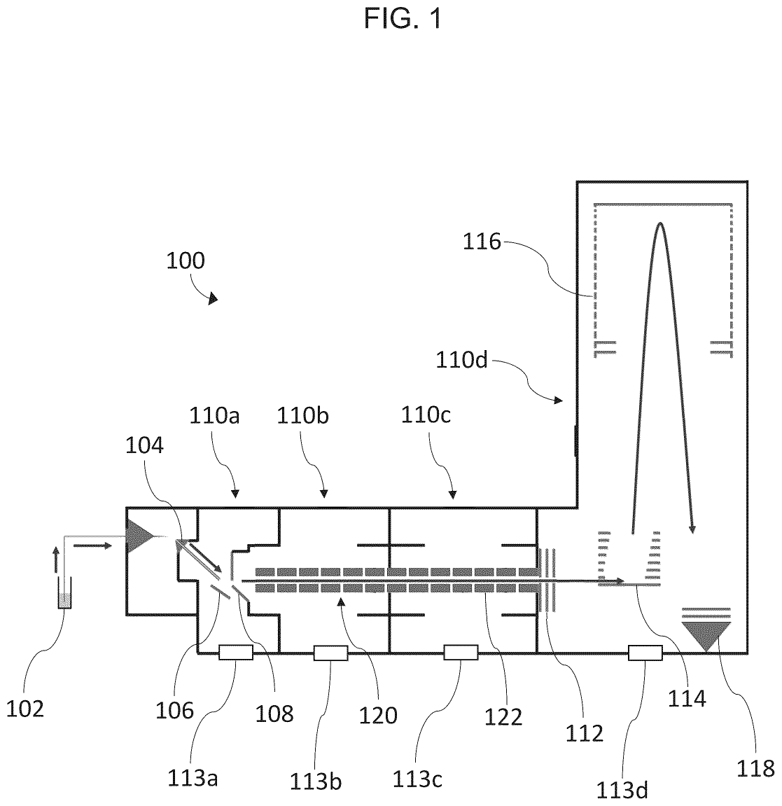

FIGS. 1-8 disclose features of mass spectrometer systems. FIG. 1 shows a schematic diagram of an exemplary mass spectrometer 100. In some embodiments, the mass spectrometer 100 may include a plurality of chambers 110a, 110b, 110c, 110d, each of which may have a different pressure. For example, chamber 110a may have a pressure less than atmospheric pressure, and each of chambers 110b, 110c, 110d may have progressively lower pressures, such that chamber 110d has a sufficiently low pressure that air molecules will not affect (or will minimally affect) the flow of ions through the chamber 110d to a detector 118. In an exemplary embodiment, chamber 110a may have a pressure between 0.1 and 10 torr or, preferably, approximately 1 torr. Chamber 110b may have a pressure between 0.001 and 0.1 torr or, preferably, approximately 0.01 torr. Chamber 110c may have a pressure between 10-5 and 10-3 torr or, preferably, approximately 10-4 torr. Chamber 110d may have a pressure between 10-8 and 10-5 torr or, preferably, approximately 10-7 torr. In some embodiments, a greater or lesser number of chambers may optionally be provided, and the pressures in each chamber may optionally be varied from the values described herein.

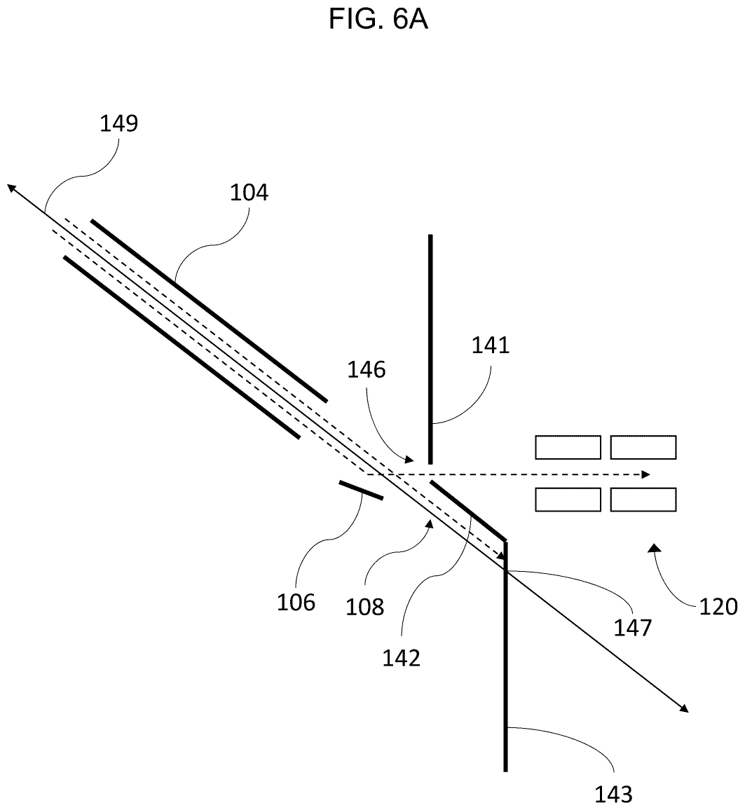

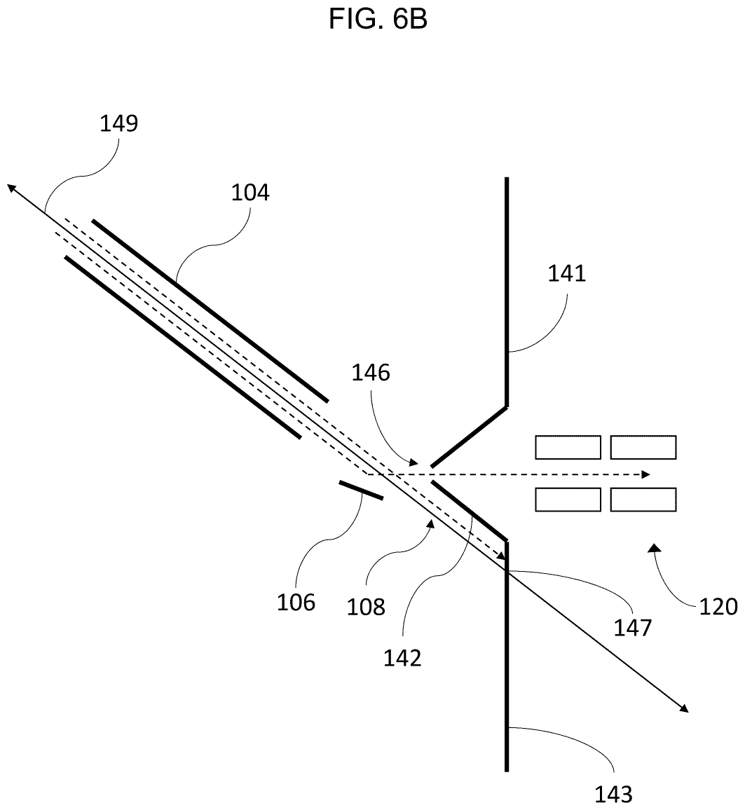

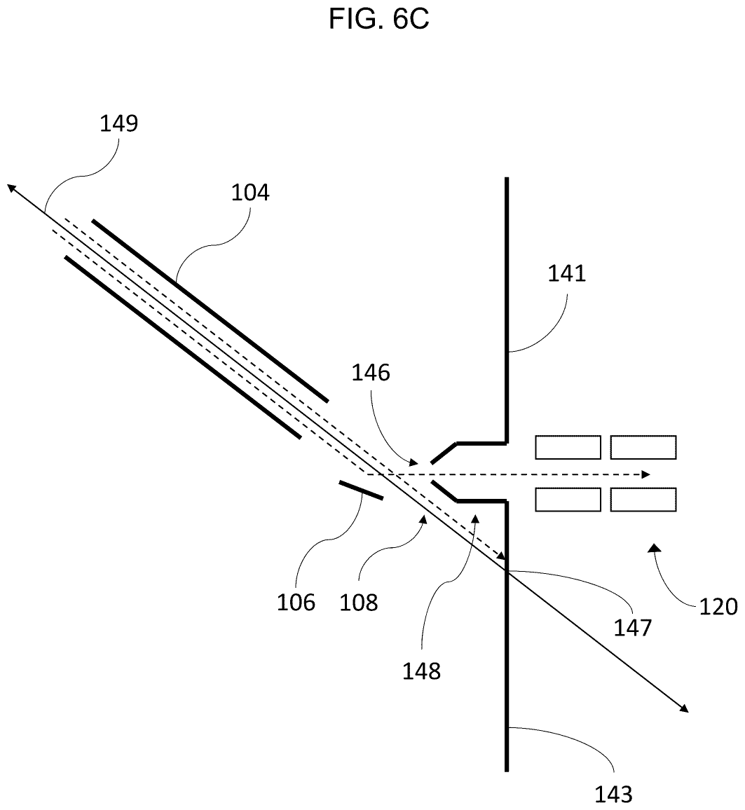

In some embodiments, mass spectrometer 100 may include a source 102 configured to output one or more ions. In some embodiments, the source 102 may include a chamber in which a sample may be received. The source 102 may further include a device for applying energy to and ionizing molecules in the sample. In some embodiments, the source may use capillary electrophoresis and/or electrospray ionization. In some embodiments, ions may flow from the source 102 to a tube 104. Ions may flow from the tube 104 may toward a deflector 106 and then to a skimmer 108. The skimmer 108 may allow ions that are on an intended path to travel into a particle guide 120. Ions that deviate from the intended path may be blocked by the skimmer and may be prevented from entering the particle guide 120. Exemplary skimmer arrangements are described in greater detail below with respect to FIGS. 6A-6C.

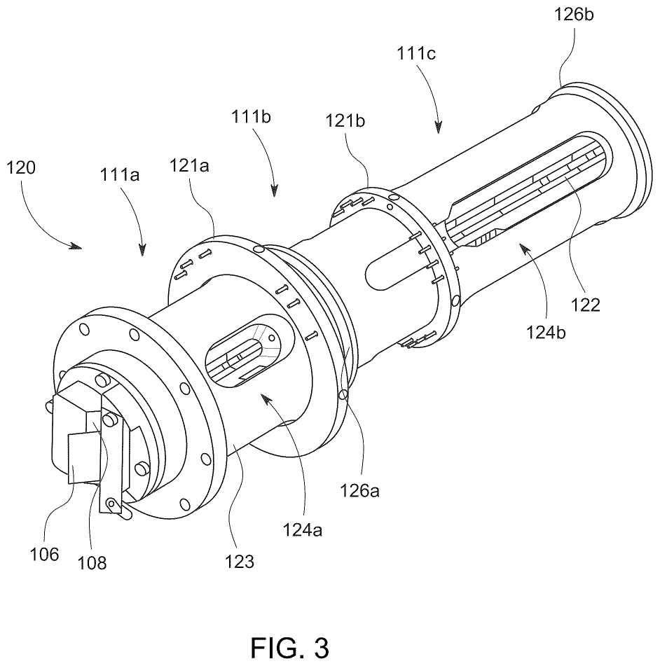

In some embodiments, the particle guide 120 may include a quadrupole, as described in greater detail below with respect to FIGS. 3-5. The particle guide may include a plurality of segments 122 which may apply electric fields to guide and manipulate the flow of ions through a length of the particle guide. FIG. 1 shows an exemplary particle guide with thirteen quadrupole segments. Particle guides may optionally have a greater or lesser number of segments than shown in this embodiment. The particle guide may terminate at a lens gate 112, which may selectively allow ions to pass into chamber 110d. In some embodiments, lens gate 112 may be affixed to or integrated with particle guide 120. In other embodiments, lens gate 112 may be adjacent to particle guide 120. Lens gate 112 may have a first state in which it is open to passage of ions from particle guide 120 to chamber 110d, and it may have a second state in which it blocks the flow of ions from particle guide 120 to chamber 110d. Lens gate 112 may be configured to selectively switch between the first state and the second state based on signals provided by a controller.

In some embodiments, mass spectrometer 100 may include a pusher 114, a reflectron 116, and a detector 118. Pusher 114 may include a plurality of conductive elements (e.g., stacked plates that are electrically isolated from one-another) which may be selectively charged at different voltages. Ions may be configured to travel from lens gate 112 to a channel within pusher 114, and the pusher 114 may generate an electric gradient that causes the ions to accelerate through the pusher channel toward reflectron 116. Reflectron 116 may include a plurality of conductive rings or other elements that can be selectively charged at different voltages, thereby generating an electric gradient that is configured to reflect ions toward detector 118. Detector 118 may be configured to detect the arrival of each ion that contacts the detector 118 and record a precise time of each arrival. In some embodiments, detector 118 may be a microchannel plate, which may be configured to detect individual ions.

In use, a sample may be placed in source 102 and energized to produce ions. The ions may flow from source 102 to tube 104, to deflector 106, and through skimmer 108 to particle guide 120. Ions may then travel through particle guide 120, which may confine the travel of ions and, in some embodiments, reduce their kinetic energy. Ions may then travel through lens gate 112 and to pusher 114. Ions may be accelerated by pusher toward reflectron 116 and then reflected toward detector 118, where their time of arrival may be recorded.

An ion's time of flight from pusher 114 to detector 118 may vary based on the mass and charge of the ion. For example, ions with greater mass may accelerate more slowly at pusher 114 and reflectron 116, resulting in a longer time of flight to detector 118. Greater charge, conversely, may produce higher acceleration, resulting in a shorter time of flight to detector 118. By accurately measuring the time from when the pusher 114 begins accelerating the ions and when those ions arrive at detector 118, the mass and charge of the ions may be inferred, and the composition of the sample at source 102 may be analyzed.

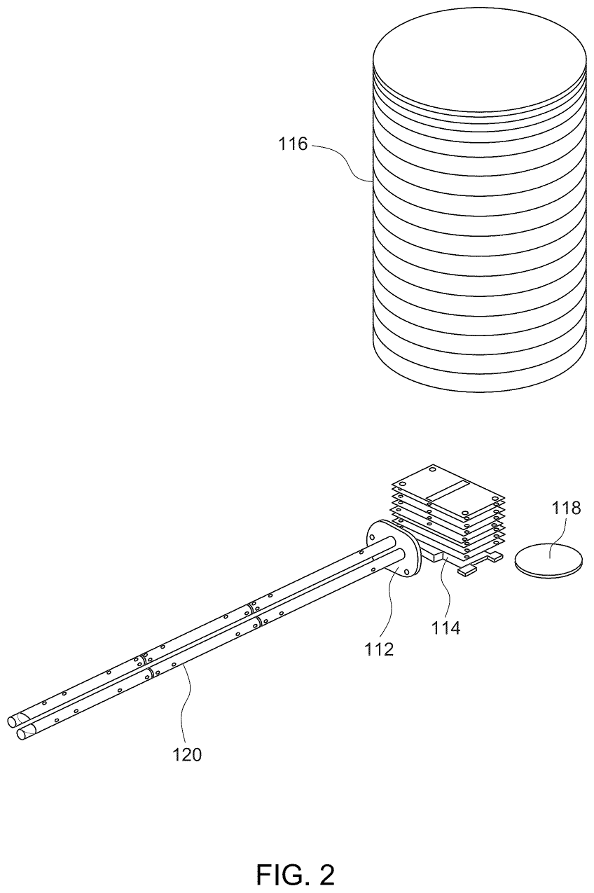

FIG. 2 shows a perspective view of certain components of a mass spectrometer. As described above in the schematic diagram shown in FIG. 1, FIG. 2 shows a particle guide 120, a lens gate 112, a pusher 114, a reflectron 116, and a detector 118.

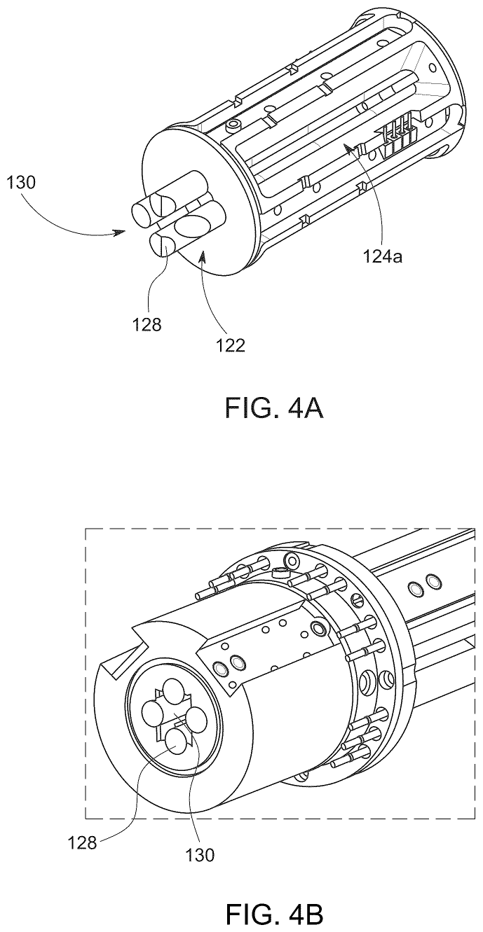

FIG. 3 shows an exemplary particle guide 120. Particle guide 120 may include a housing 123, which may enclose electrical components and provide a rigid support with which the particle guide 120 may be affixed within a mass spectrometer. A plurality of quadrupole segments 122 may be disposed within the housing 123. As shown in greater detail in FIGS. 4A and 4B, each quadrupole segment 122 may include four conductive members 128 which may be disposed around a central channel 130. The conductive members 128 may be selectively charged, such that the conductive members of a quadrupole segment, in conjunction with other quadrupole segments of the particle guide, may direct and manipulate the flow of ions through the central channel 130 of the particle guide. The central channel 130 may extend along an entire length of the particle guide.

In some embodiments, a deflector 106 and a skimmer 108 may be affixed to the particle guide. The deflector 106 and skimmer 108 may be configured to perform the functions described above with reference to FIG. 1 and below with reference to FIGS. 6A-6C.

The particle guide 120 may include sections 111a, 111b, 111c. In some embodiments, section 111a may be an open section that includes a vent 124a that provides a passage from an exterior of section 111a to the central channel 130. For example, the passage defined by vent 124a may extend between two of four conductors 128 of one or more quadrupole segments 122 in section 111a.

Section 111c may also be an open section. Section 111c may include a vent 124b that provides a passage from an exterior of section 111c to the central channel 130. For example, the passage defined by vent 124b may extend between two of four conductors 128 of one or more quadrupole segments 122 in section 111c. Section 111b may preferably be a closed section that does not include a vent. Additional open or closed sections may optionally be provided.

The particle guide 120, including sections 111a, 111b, 111c, may be disposed in a mass spectrometer having multiple chambers at different pressures. Section 111a may, for example, be disposed in a first chamber (such as chamber 110b in FIG. 1) having a first pressure, and section 111c may, for example, be disposed in a second chamber (such as chamber 110c in FIG. 1). Vent 124a may provide a passage from the first chamber to the central channel, and vent 124b may provide a passage from the second chamber to the central channel. Thus, the portion of the central channel near vent 124a may be equal or approximately equal to the pressure in the first chamber, and the portion of the central channel near vent 124b may be equal or approximately equal to the pressure in the second chamber.

A pressure differential may exist along the portion of the central channel spanning from the first vent 124a to the second vent 124b. The flow of air molecules may be limited by a fluid conductance of the closed section 111b. For example, a fluid conductance of the closed section 111b may be determined by a cross-sectional area of the opening in channel 130 and a length of the closed section. By making the fluid conductance sufficiently low (e.g., because the cross-sectional area is sufficiently small and the length of the closed section is sufficiently large), the flow of air from a higher-pressure chamber to a lower-pressure chamber may be reduced to a level that can be offset using a vacuum pump or other device, thereby maintaining the pressure differential at a desired state. In some embodiments, the length of the closed segment may be at least 1 cm, at least 40 cm, or, more preferably, at least 4 cm. In some embodiments, the open cross-sectional area of the channel 130 may be less than 0.05 cm2, less than 5 cm2, or, more preferably, less than 0.3 cm2. In some embodiments, the fluid conductance of the closed section may be less than 0.01 liters per second, less than 10 liters per second, or more preferably, less than 1 liter per second. As illustrated in FIG. 1, one or more vacuum pumps 113a, 113b, 113c, 113d may be arranged to remove air molecules from chambers 110a, 110b, 110c, 110d respectively. The one or more vacuum pumps may be directly affixed to a housing of the mass spectrometer 100, or they may be coupled to the chambers via hoses. In some embodiments, the vacuum pumps may be roughing pumps, such as rotary vanes or scrolls, or a turbomolecular pump. In some embodiments, a higher-powered pump may be used for chambers 110b, 110c, and/or 110d than for chamber 110a. For example, a rotary vane may be connected to chamber 110a, and a three-stage turbo pump may be connected to chambers 110b, 110c, and 110d. Other pumping arrangements may be used.

When arranged in a mass spectrometer such as that shown in FIG. 1, open section 111a may be disposed in chamber 110b, open section 111c may be disposed in chamber 110c, and closed section 111b may be disposed across a juncture between chambers 110a and 110b. In this manner, a single particle guide may be disposed across multiple chambers at different pressures without producing unacceptable levels of gas flow across the chambers. This may advantageously reduce the number of separate particle guides that need to be provided and installed in a mass spectrometer, thereby reducing the cost of the mass spectrometer and improving the consistency and reliability of the device's performance.

Particle guide 120 may include one or more circumferential rings 121a, 121b, which may be configured to receive electrical contacts for controlling electric fields in the particle guide. In some embodiments, rings 121a, 121b may alternatively or additionally be used to provide mechanical supports against which the particle guide 120 may be affixed within a mass spectrometer. In some embodiments, the rings 121a, 121b may be replaced with mechanical supports having different geometries. For example, the supports may be protrusions extend for less than the full circumference of the housing or have flat outer surfaces (e.g., a triangular, rectangular, pentagonal, or hexagonal projection).

In some embodiments, particle guide 120 may also include one or more sealing rings 126a, 126b. Sealing rings 126a, 126b may be made from a deformable material such as rubber or an elastomeric polymer, such that a sealing connection may be formed when the sealing ring contacts a surface. In some embodiments, when the particle guide 120 is installed in a mass spectrometer, the sealing rings 126a, 126b may be aligned with and contact walls between adjacent chambers. For example, with reference to FIG. 1, sealing ring 126a may be disposed such that it contacts the inner surface of an aperture in the wall between chamber 110b and chamber 110c. Sealing ring 126b may be disposed such that it contacts the inner surface of an aperture in the wall between chamber 110c and chamber 110d.

FIGS. 4A and 4B show cross-sectional views of the particle guide 120 shown in FIG. 3. In these figures, housing 123 has been omitted to more clearly show interior components of the particle guide 120.

FIG. 4A shows open section 111a of the particle guide 120. Particle guide 120 may include one or more quadrupole segments 122, each of which may include four conductive members 128 to which a voltage may be applied. Four quadrupole segments are visible in the section of the particle guide shown in FIG. 4A. The quadrupole segments 122 may be disposed around a central channel 130, which may define a path through which ions may flow through the length of the particle guide. Vent 124a may form a passage from an exterior of the particle guide to an interior of the particle guide 120 and, more specifically, to the central channel 130.

FIG. 4B shows closed section 111b of the particle guide 120. The open cross-sectional area of central channel 130 can be seen in FIG. 4B. By increasing or decreasing this cross-sectional area, a fluid conductance of the closed section may be modified.

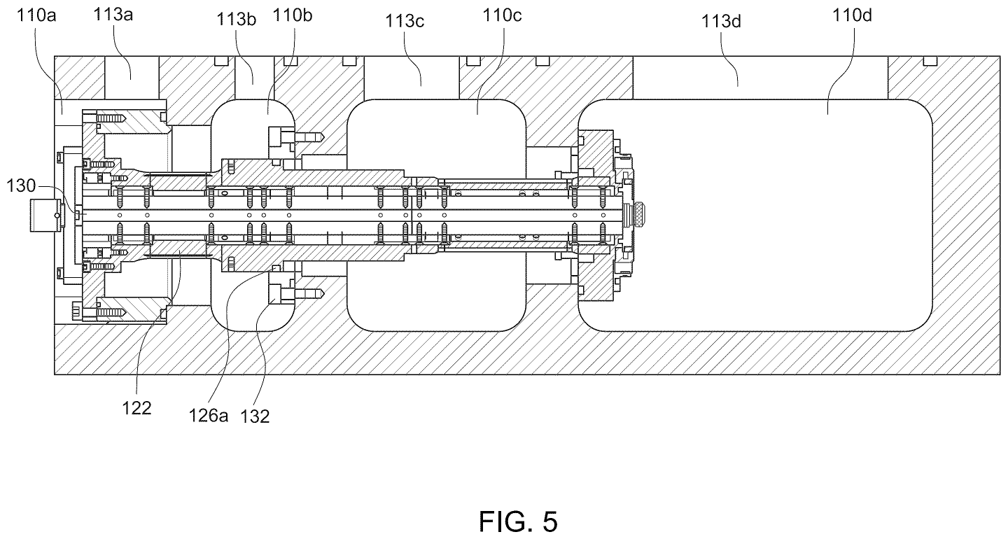

FIG. 5 shows a longitudinal cross-sectional view of the particle guide 120 as installed in the mass spectrometer shown in FIG. 1. As shown in FIG. 5, a mounting piece 132 may be affixed via bolts or other fixtures to a wall disposed between chambers 110b and 110c. The mounting piece 132 may be pressure fitted or otherwise coupled to housing 123 of the particle guide. Sealing ring 126 may be disposed between mounting piece 132 and housing 123 to provide an airtight seal between these components. The same or similar structures may be provided at other sections where the particle guide 120 is affixed to the mass spectrometer. For example, the same or similar structures may be provided at a distal end of particle guide 120 (e.g., around sealing ring 126b) where particle guide 120 may be affixed to a wall between chamber 110c and chamber 110d.

FIGS. 6A-6C show an exemplary skimmer arrangements for receiving ions. As shown in FIG. 6A, a skimmer arrangement may include one or more surfaces which may be geometrically arranged to reduce the risk of contamination surrounding an aperture 146. In the exemplary embodiment of FIG. 6A, a first surface 141 may be disposed at a nonzero angle relative to a second surface 143, and a third surface 143 may be disposed at a nonzero angle relative to the second surface 143. In some embodiments, the first surface 141 and the third surface 143 may be parallel to one-another or within 5 degrees of parallel to one-another. The second surface 142 may be disposed at an angle that is parallel to a central axis of tube 104. Alternatively, the second surface may be disposed at an angle that is closer to parallel to the central axis of tube 104 than are either of surface 141 or surface 143.

As described above with respect to FIG. 1, particles may generally flow from a source through a tube 104. As used herein, the term “particle” broadly includes collections of matter that can travel collectively as a unit through a mass spectrometer or portion thereof, and includes both individual molecules and larger groups of matter such as droplets, and may further include ions, heavy charged molecules or groups of matter, and neutral species. In some embodiments, tube 104 may be a capillary 104. A range of particles having different charge-to-mass ratios may enter the flowpath, where they may be deflected by a voltage on a deflector 106. As used herein, the term “deflector” broadly includes any element that has the purpose or effect of diverting a direction of a stream of charged particles, without regard to the element's geometry, and may include both flat and curved electrodes and other structures such as tubular lenses. Additionally, variations in particle trajectory may be observed.

Two exemplary, simplified flow paths are shown in dotted lines in FIG. 6A. In the case of a first particle path, the particle may be repelled by deflector 106 and directed through an aperture between in surface 141 or between surfaces 141 and 142 of skimmer 108 and into particle guide 120. A second particle may not be redirected or may be minimally redirected by deflector (e.g., due to low charge-to-mass ratio or misalignment) and may travel past the aperture and contact a surface 143 that is spaced a distance from the aperture. Surface 143 may include a point 147 that intersects a central axis 149 of tube 104. The geometry of the skimmer 108 may be such that point 147 is spaced a distance from aperture 146, and the central axis 149 has a clear path to point 147 (i.e., the central axis does not intersect another portion of skimmer 108 before reaching point 147). In some embodiments, the clear path may be such that a cylinder surrounding the central axis 149 having a radius of 1, 2, 3, or 5 mm may not intersect any portion of the skimmer until the cylinder reaches the point 147. In some embodiments, the distance between aperture 146 and point 147 may be at least 500 microns, at least 1 mm, at least 3 mm, at least 5 mm, at least 10 mm, at least 20 mm, at least 50 mm, or at least 100 mm.

FIGS. 6B and 6C show additional exemplary skimmer geometries. As shown in FIG. 6B, surface 142 may be a portion of a cone that extends toward or includes aperture 146. As shown in FIG. 6C, the aperture 146 may be disposed on an extension 148 or other surface that is spaced from surface 143. Optionally, the extension or spaced surface may include a cone or other portion having a surface that is substantially parallel to a central axis of tube 104. In other embodiments, this may be omitted, and the geometry of the extension or spaced surface may be used to ensure that uncharged particles which present a contamination risk predominantly travel a distance from the aperture 146. As in FIG. 6A, the geometries of the skimmer embodiments shown in FIGS. 6B and 6C may be such that point 147 is spaced a distance from aperture 146, and the central axis 149 has a clear path to point 147. The distance between aperture 146 and point 147 may be at least 500 microns, at least 1 mm, at least 3 mm, at least 5 mm, at least 10 mm, at least 20 mm, at least 50 mm, or at least 100 mm.

By angling surface 142 as shown in FIGS. 6A and 6B, particles that are not redirected or are minimally redirected by deflector will tend to travel a distance away from the aperture before contacting the skimmer. Alternatively, by using a projection or other spaced surface as sown in FIG. 6C, particles that are not redirected or are minimally redirected by deflector may likewise tend to travel a distance away from the aperture before contacting the skimmer. In some embodiments, at least 50%, at least 75%, at least 85%, at least 90%, at least 95%, at least 97%, at least 99%, or at least 99.5% of the uncharged particles that travel through the tube and are deposited on the skimmer may be deposited at least a distance from the aperture. In some embodiments, the distance may be at least 500 microns, at least 1 mm, at least 3 mm, at least 5 mm, at least 10 mm, at least 20 mm, at least 50 mm, or at least 100 mm. This may beneficially reduce the rate at which misaligned particles contact and are deposited on or around the aperture, where they can potentially become dislodged during future measurements and enter the particle guide. Notably, contamination issues are most frequently caused by droplets and heavy charged or neutral particles, which are not redirected or only minimally redirected by deflector 106. These particles may therefore reliably travel away from the aperture to surface 143, where they present little risk of contaminating future measurements. Accordingly, the skimmer arrangements shown in FIGS. 6A-6C may reduce the risk that deposited particles contaminate future measurements, thereby improving the accuracy and reliability of the mass spectrometer. Neutral gas molecules that travel through the tube may be predominantly pumped out of the mass spectrometer by a vacuum pump, rather than being deposited on a surface. While some heavier molecules may in theory be suspended in air traveling through the mass spectrometer and to deposit on surfaces within the mass spectrometer, this phenomenon has been found to cause minimal contamination.

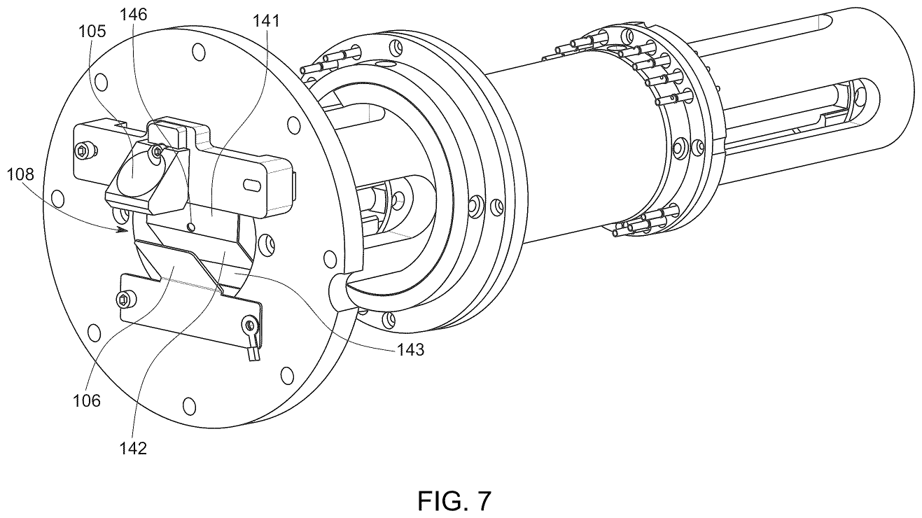

FIG. 7 shows a perspective view of an exemplary skimmer 108. As shown in FIG. 7, particles may approach skimmer 108 by traveling through a capillary disposed in recess 105. A voltage may be applied to deflector 106 such that deflector 106 may redirect charged particles as the exit the capillary. Charged particles may be redirected by deflector 106 into aperture 146 in surface 141, from which the particles may travel through a particle guide, such as the particle guides described above.

In some embodiments, surface 142 may be substantially parallel to a central axis of tube 104. For example, surface 142 may be within 30° of parallel to the central axis of tube 104, 20° of parallel to the central axis of tube 104, within 15° of parallel to the central axis of tube 104, 10° of parallel to the central axis of tube 104, within 8° of parallel to the central axis of tube 104, within 6° of parallel to the central axis of tube 104, within 4° of parallel to the central axis of tube 104, within 2° of parallel to the central axis of tube 104, or within 1° of parallel to the central axis of tube 104. In some embodiments, a distance between aperture 146 and the portion of surface 142 that is most proximate to aperture 146 may be less than 10 mm, less than 5 mm, less than 1 mm, less than 500 microns, less than 100 microns, less than 50 microns, or less than 10 microns.

Uncharged particles and particles with high mass-to-charge ratio may continue to travel along a path substantially parallel to the length of the capillary and may contact surface 143. These particles (and constituents thereof) may therefore be deposited a distance from aperture 146 and may present little risk of contaminating future measurements.

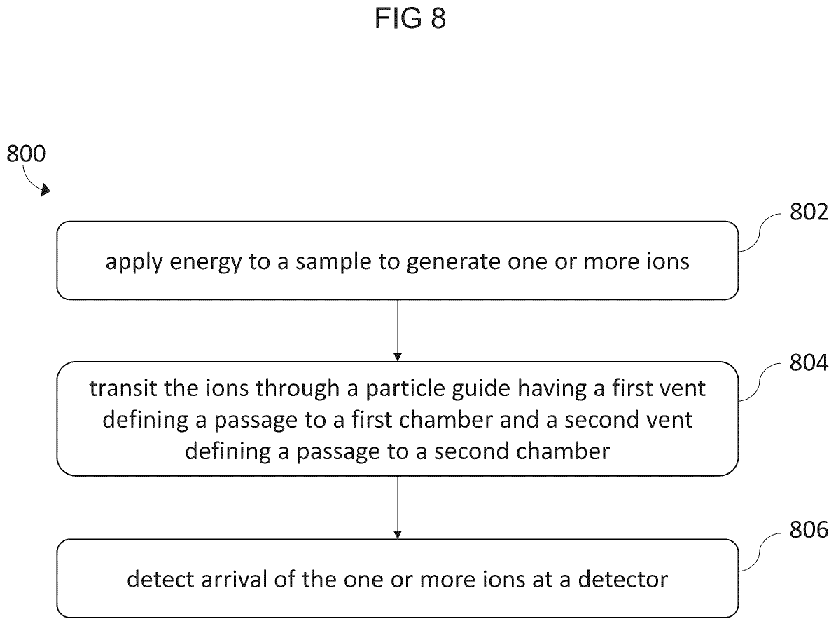

FIG. 8 shows an exemplary method 800 for analyzing a sample. Method 800 may be performed using a mass spectrometer having a particle guide as generally described above with respect to FIGS. 1-5. For example, method 800 may be performed using a mass spectrometer having a plurality of chambers having different pressures including at least a first chamber having a first pressure that is less than atmospheric pressure and a second chamber having a second pressure that is less than the first pressure. The mass spectrometer may include a particle guide including a conduit through which the one or more ions may travel an entire length of the particle guide and a housing surrounding the conduit. The housing may define a first open section comprising a first vent, the first vent being configured to define a passage between the first chamber and the conduit, a second open section comprising a second vent, the second vent being configured to define a passage between the second chamber and the conduit, and a closed section disposed between the first open section and the second open section.

In step 802, energy may be applied to a sample to generate one or more ions. For example, capillary electrophoresis and/or electrospray ionization may be used to generate the ions. Ions may then flow from the sample toward the particle guide, optionally via one or more of a capillary, a deflector, and/or a skimmer. In step 804, the ions may be transited through the length of a particle guide. The particle guide may be disposed across multiple chambers of the mass spectrometer at different pressures. In some embodiments, the particle guide may have a first vent defining a passage to the first chamber of the mass spectrometer and a second vent defining a passage to the second chamber of the mass spectrometer. To reduce the flow of air molecules along a pressure differential between the chambers, the vents may be spaced by a closed section having a cross-sectional area and length selected to provide a sufficiently low fluid conductance. To maintain the desired pressure states, the chambers of the mass spectrometer may additionally be continuously or intermittently evacuated using a vacuum pump.

In step 806, a detector may detect an arrival of the ions at the detector. In some embodiments, the detector may be configured to detect the arrival of each ion that contacts the detector and record a precise time for each arrival. In some embodiments, detector may be a microchannel plate. In some embodiments, a time between when a pusher begins accelerating the ions and when those ions arrive at the detector may be analyzed to determine a composition of the sample.

### 2. Bench System to Support a Mass Spectrometer

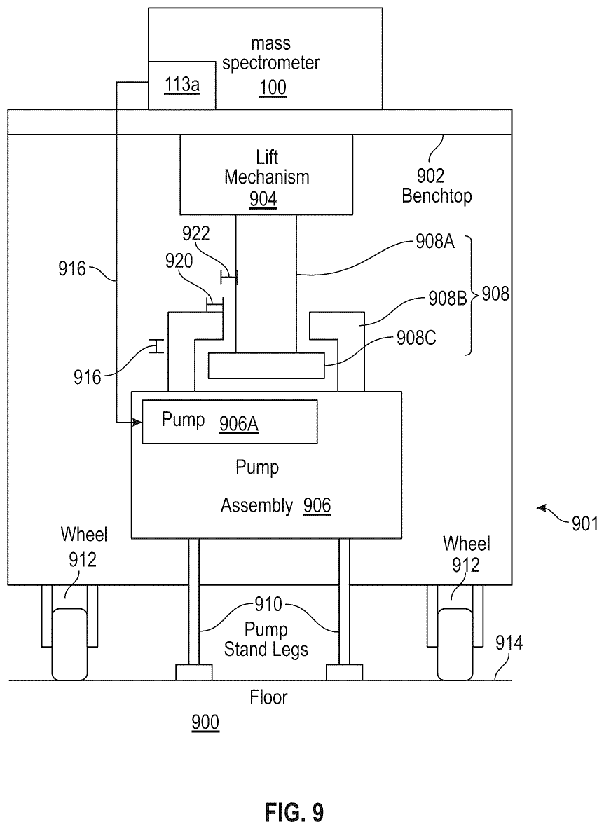

FIGS. 9-12 disclose features of a bench system to support a mass spectrometer. The features of FIGS. 9-12 may apply to any of FIGS. 1-8.

The lift mechanism 904 in the bench system (e.g., bench system 901 and/or bench system 1101) offers several benefits that enhance the functionality and usability of the bench system. In some aspects, the lift mechanism 904 provides vibration isolation for the mass spectrometer 100 by allowing the pump assembly 906 to rest securely on the floor during operation. This isolation is particularly beneficial for maintaining the precision and accuracy of mass spectrometry measurements, as it minimizes the transmission of vibrational energy from the pump to the mass spectrometer 100.

Additionally, the lift mechanism 904 enables the bench system to transition between stationary and mobile states. When the pump assembly 906 is lifted off the floor, the bench system can be easily moved to different locations within a laboratory or facility. This mobility is advantageous for reconfiguring workspaces, sharing equipment between different users or departments, or performing maintenance and cleaning operations.

Furthermore, the lift mechanism 904 may be designed to accommodate various types of actuation, such as manual or electronic, providing flexibility in how the bench system is operated. For instance, a manual lift mechanism may be preferred in environments where electronic devices are restricted, while an electronically driven lift mechanism may offer convenience and ease of use in other settings.

The inclusion of a load shaft and load shaft flange, as well as the potential for L-brackets or alternative lifting structures, allows for a robust and reliable lifting action. This design ensures that the pump assembly 906 can be securely engaged and disengaged from the floor without requiring excessive force or complex procedures.

In some cases, the lift mechanism's design may also facilitate the integration of a drawer and rail system for the pump assembly. This integration allows for the pump 906A to be easily slid in and out for maintenance or replacement, further enhancing the serviceability of the bench system. Such a feature is particularly valuable in high-throughput environments where downtime for maintenance can be costly.

Overall, the lift mechanism 904 contributes to a bench system that is versatile, user-friendly, and conducive to maintaining the high performance of mass spectrometry equipment. It addresses both the operational demands of vibration isolation and the practical considerations of mobility and maintenance.

In some aspects, the bench system is designed with specific spacing elements to reduce the transmission of vibrations from the pump to the mass spectrometer, thereby preserving the integrity of the mass spectrometry analysis. The pump assembly, which supports the pump, includes legs and feet that rest on the floor. These legs and feet may be constructed with materials and geometries optimized for damping vibrations. Additionally, the spacing between the pump assembly and the bench, facilitated by the lift mechanism, plays a role in vibration isolation.

The lift mechanism itself may incorporate features such as a load shaft and a load shaft flange that interact with brackets on the pump assembly. When the pump assembly is in a first state, resting on the floor, there may be a predetermined first space between the load shaft and the brackets and a predetermined second space between the load shaft flange and the brackets. This space may be designed to ensure that when the pump is operational, any vibrations are not transmitted to the bench/mass spectrometer. The load shaft flange may have an overlap distance with the brackets that is sufficient to engage and lift the pump assembly when the mass spectrometer is not in operation.

Furthermore, the pump assembly legs may include vibration-damping feet, which may be made of rubber or a similar material. These feet can absorb and dissipate vibrational energy from the pump, reducing the amount of vibration that reaches the floor and, consequently, the bench system. The combination of these spacing and damping elements contributes to the overall effectiveness of the vibration isolation strategy, ensuring that the mass spectrometer operates with the precision and accuracy expected in sensitive analytical procedures.

### 2.A. 1^{st} Bench System

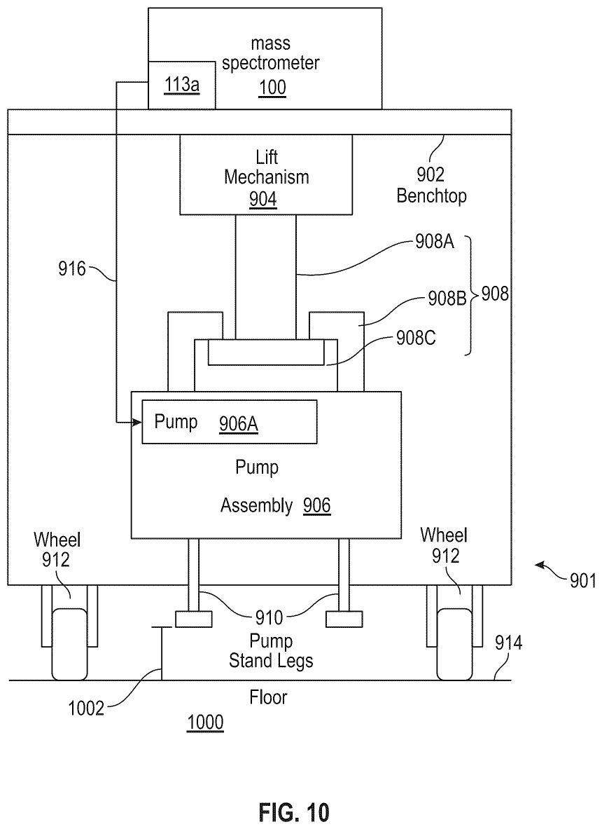

FIGS. 9 and 10 depict a bench system 901 to support a mass spectrometer 100 in accordance with a first embodiment. FIG. 9 depicts the bench system 901 in a first state 900, while FIG. 10 depicts the bench system 901 in a second state 1000.

FIG. 9 depicts the bench system 901 in the first state 900. In some aspects, the bench system 901 may be a cart. The bench system 901 is configured to support, and in some cases secure, a mass spectrometer 100. The bench system 901 includes a bench 902 configured to support the mass spectrometer 100. In some cases, the bench system 901 includes a pump assembly 906 configured to support a pump 906A. The pump assembly 906 may support, and in some cases secure, the pump 906A. The pump 906A may be connected by a hose 916 to a port 113a of the mass spectrometer 100. In some cases, the bench system 901 also includes a lift mechanism 904 configured to move the pump assembly 906 between the first state 900 and the second state 1000.

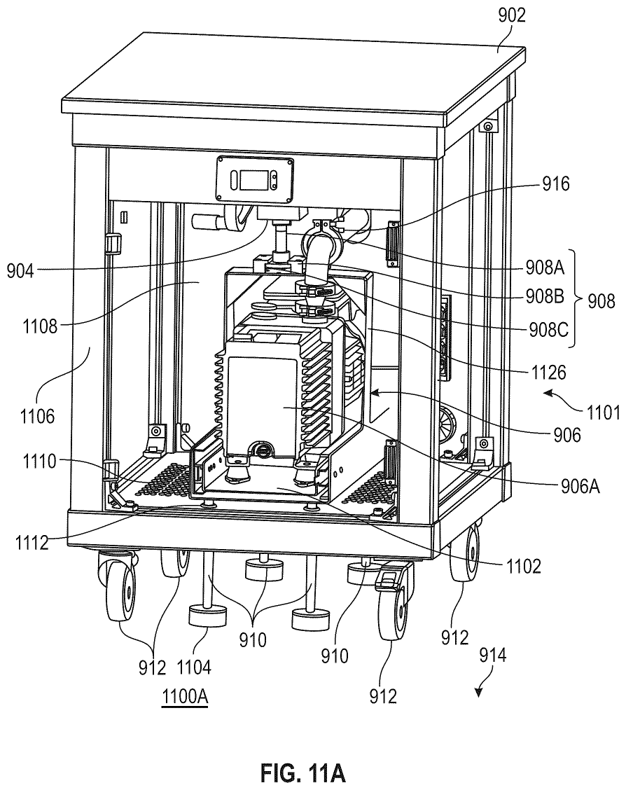

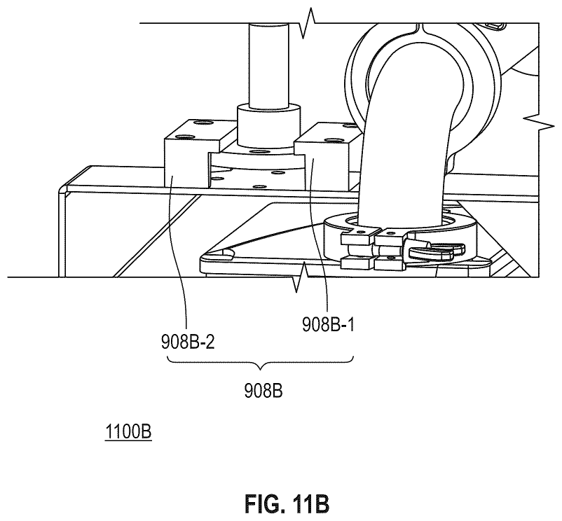

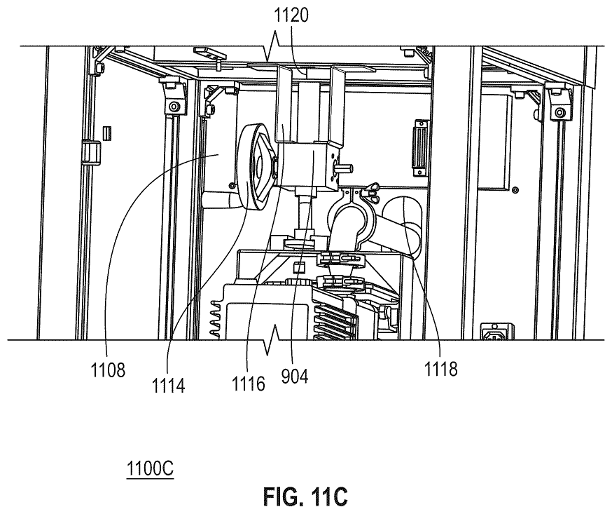

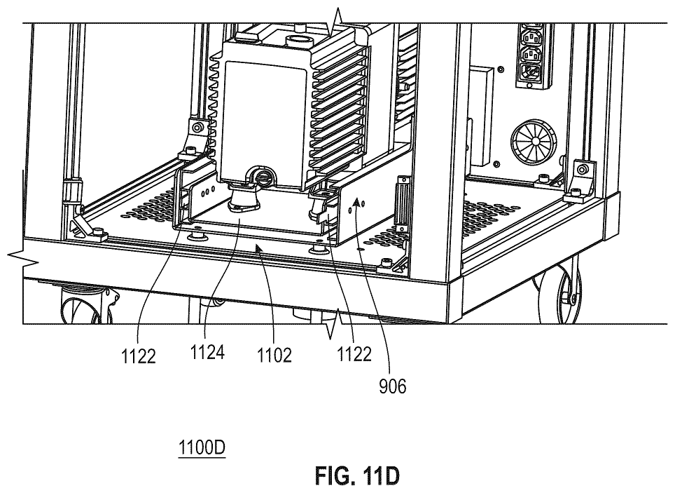

In some aspects, the lift mechanism 904 is mounted beneath the bench 902. In other cases, the lift mechanism 904 may be mounted to side panels, posts, or a bottom panel of the bench system 901. The lift mechanism 904 may include a jack screw gear box, electrical linear actuator, a mechanical lifting lever or the like. The lift mechanism 904 may be driven by an actuator 1114 (e.g., manually or electronically by a motor). Moreover, the lift mechanism 904 may include an interface 908. The interface 908 may selected from different structures or means of moving the pump assembly 906. For example, instead of L-brackets (see, e.g., FIG. 11C), the pump assembly 906 may have a cylinder with a counter bore that allows it to be lifted. Alternatively, the load shaft flange could have holes in it and the pump assembly could have shoulder screws that allow it to be lifted. In another variation, the lift mechanism 904 could be connected to a cable that connects to the pump assembly 906 and allows the pump assembly 906 to be lifted. These modifications may provide additional flexibility and adaptability in different operational contexts.

The lift mechanism 904 may be connected to the pump assembly 906 by the interface 908. In some cases, the interface 908 may include a load shaft 908A, a load shaft flange 908C, and brackets 908B (connected to the pump assembly 906). The lift mechanism 904 may interact with the load shaft 908A to thereby move the load shaft flange 908C. The load shaft flange 908C is configured to disengage and engage the brackets 908B of the pump assembly 906, to thereby move the pump assembly 906.

The load shaft flange 908C may have an overlap distance 920 with the brackets 908B. The overlap distance 920 may define a surface of the load shaft flange 908C that engages a surface of the brackets 908B. The brackets 908B may be spaced apart from the load shaft 908A by a first space 922. The first space 922 may ensure that the brackets 908B do not engage the load shaft 908A. In some cases, the first space 922 may be defined by an opening in the brackets 908B, so that the load shaft 908A may move therein.

In the first state 900, the bench system 901 may have a second space 918 between the load shaft flange 908C and the brackets 908B. The first space 918 and second space 922 may ensure that the pump assembly 906, and thereby, the pump 906A, are vibrationally isolated from the rest of the bench system 901 when the pump 906A is operational. Thus, vibrations from the pump 906A may be isolated from the mass spectrometer 100 when the mass spectrometer 100 is operational.

The pump assembly 906 is supported by the pump assembly legs 910. In the first state 900, the pump assembly 906 is engaged with a floor 914 by the pump assembly legs 910. The bench system 901 may be equipped with wheels 912 for mobility. In some aspects, the load shaft flange 908C is a disc with a larger diameter than the load shaft 908A.

FIG. 10 depicts the second state 1000 of the bench system 901. In the second state 1000, the bench system 901 has engaged the lift mechanism 904 via the interface 908 to move the pump assembly 906 from the first state, where it is at rest on a floor 914, to the second state 1000. In this second state 1000, the pump assembly 906 is moved off the floor 914 by a third distance 1002. This movement allows the bench system 901 to be moved as a single unit, including the pump assembly 906 and pump 906A.

Later, the bench system 901 may engage the lift mechanism 904 to move (via the interface 908) the pump assembly 906 from the second state 1000 back to the first state, where it is at rest on the floor 914. This movement and positioning of the pump assembly 906 in the first state may serve to isolate vibrations from the pump 906A from the mass spectrometer 100 while the mass spectrometer 100 is in use. This isolation of vibrations may be beneficial in maintaining the accuracy and precision of the mass spectrometer 100. Furthermore, the ability to move the pump 906A with the bench system 901 as a single unit may provide convenience and flexibility in the operation and positioning of the bench system 901.

### 2.B. 2^{nd} Bench System

FIGS. 11A-11D depict a bench system 1101 to support a mass spectrometer 100 in accordance with a second embodiment. FIGS. 11A-11D may depict features of the bench system 1101.

FIG. 11A depicts a first view 1100A of a bench system 1101. The bench system 1101 may be the same as or different than the bench system 901. In some aspects, the bench system 1101 includes a bench 902, a lift mechanism 904, and a pump assembly 906. The pump assembly 906 may be connected to the lift mechanism 904 via an interface 908, which includes a load shaft 908A, brackets 908B, and a load shaft flange 908C. The pump assembly 906 may be supported by pump assembly legs 910 and may be equipped with wheels 912 for mobility. The pump 906A may be connected to the mass spectrometer 100 via a hose 916. The bench system 1101 may rest on a floor 914 and the pump assembly 906 may be moved from a first state to a second state.

In some cases, the pump assembly 906 of the bench system 1101 may include a rail system 1102 to secure the pump 906A and a pump assembly structure 1126. The pump assembly structure 1126 may support the pump 906A (e.g., by supporting the rail system 1102), connect to the interface 908 (e.g., by the brackets 908B and connecting members between the brackets 908B and the rail system 1102), and connect to (and be supported by) the pump assembly legs 910. The pump assembly legs 910 of the bench system 1101 may include feet 1104. The feet 1104 may be made of rubber or other material to absorb vibrations of the pump 906A, thereby reducing any vibration transferred by the floor 914 to the bench system 1101.

The bench system 1101 may include a support frame 1106, such as posts, and one or more wall panels 1108, which may include doors. The bench system 1101 may also include a floor panel 1110 with one or more openings 1112, so that the pump assembly legs 910 may pass through the floor panel 1110 without engaging, thereby preventing the transmission of vibrations to the bench system 1101 when in operation.

The rail system 1102 may allow for easy maintenance and removal of the pump assembly 906. In some aspects, the rail system 1102 may be configured to slide the pump 906A in and out for maintenance and/or removal.

FIG. 11B depicts a second view 1100B of the bench system 1101. The second view 1100B may illustrate an embodiment of the brackets 908B. In some aspects, the brackets 908B may comprise a single continuous bracket, such as a collar. In other cases, the brackets 908B may include at least two brackets, specifically a first bracket 908B-1 and a second bracket 908B-2. The first bracket 908B-1 and the second bracket 908B-2 may be L-brackets with a recess to engage the load shaft flange 908C. The brackets 908B may be secured to the pump assembly 906 using various fastening means, such as bolts, screws, and the like. The load shaft flange 908C interacts with the brackets 908B to facilitate the movement of the pump assembly 906, thereby ensuring effective vibration isolation for the mass spectrometer 100.

FIG. 11C depicts a third view 1100C of the bench system 1101. The third view 110C may depict features of the lift mechanism 904. In some aspects, the lift mechanism 904 may be supported by a support arm 1116. The support arm 1116 may cause the lift mechanism 904 to be spaced apart from the bench 902 by a fourth space 1120. This spacing may provide clearance for the load shaft 908A when the lift mechanism 904 is in operation.

The bench system 1101 may include one or more wall panels 1108 that provide structural enclosure and support. In some cases, a hose opening 1118 may be provided in the one or more wall panels 1108, such as a back panel. This hose opening 1118 may allow the hose 916 to connect the port 113a of the mass spectrometer 100 and the pump 906A. In some aspects, the hose opening 1118 may be sized to provide clearance for movement of the hose 916 when the pump assembly 906 is moved by the lift mechanism 904. For instance, the hose opening 1118 may have a height that is larger than its width, so that vertical movement of the hose 916 may be accommodated without interference from the back panel.

In some cases, the lift mechanism 904 may be connected to an actuator 1114. The actuator 1114 may cause the lift mechanism 904 to move the pump assembly 906. This movement may facilitate the transition of the pump assembly 906 between the first state and the second state, thereby enabling the bench system 1101 to be moved as a single unit.

FIG. 11D depicts a fourth view 1100D of the bench system 1101. The fourth view 1100D may depict the pump 906A supported by the rail system 1102, which facilitates the movement and maintenance of the pump 906A within and relative to the pump assembly 906. The rail system 1102 may include rails 1122 and a drawer 1124. The rails 1122 may be connected to the pump assembly 906 and the drawer 1124. The drawer 1124 may support the pump 906A, while the rails 1122 may enable the drawer 1124 to move relative to the pump assembly 906. This configuration may allow for easy access to the pump 906A for maintenance or removal. Moreover, this configuration provides a convenient and efficient way to access the pump 906A for maintenance or replacement, without requiring the disassembly of other components of the bench system 1101. The rail system 1102 may be designed to securely hold the pump 906A during operation, while allowing for easy removal when desired. This feature may enhance the usability and serviceability of the bench system 1101, particularly in environments where regular maintenance or replacement of the pump 906A is expected.

### 2.C. Flowchart

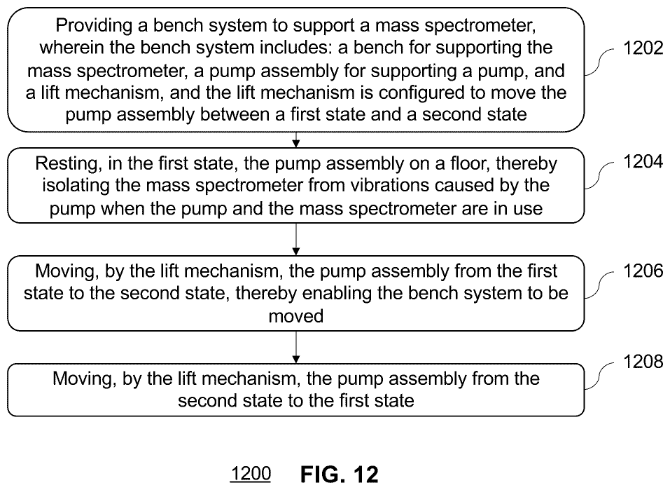

FIG. 12 depicts a flowchart 1200 for a bench system to support a mass spectrometer 100. The flowchart 1200 begins at block 1202, with providing a bench system. In some cases, the bench system may be the bench system 901 or the bench system 1101. The bench system may include a bench, such as bench 902, for supporting a mass spectrometer. The bench system may also include a pump assembly, such as pump assembly 906, for supporting a pump. Additionally, the bench system may include a lift mechanism, such as lift mechanism 904, configured to move the pump assembly between a first state and a second state.

At block 1204, the method proceeds to resting, in the first state, the pump assembly on a floor, such as floor 914, to isolate the mass spectrometer from vibrations caused by the pump when both the pump and the mass spectrometer are in use. This step may help to ensure the accuracy and precision of the mass spectrometer during operation.

At block 1206, the method proceeds to moving, by the lift mechanism, the pump assembly from the first state to a second state, thereby enabling the bench system to be moved. This step may provide flexibility and convenience in the operation and positioning of the bench system.

At block 1208, the method proceeds to moving, by the lift mechanism, the pump assembly from the second state back to the first state. This step may serve to isolate vibrations from the pump from the mass spectrometer while the mass spectrometer is in use, while (when not in use) the pump may be moved with the bench system as a single unit as desired. This step may provide convenience and flexibility in the operation and positioning of the bench system.

In some aspects, the bench system, such as bench system 901 or bench system 1101, may include additional features or variations not specifically depicted in the figures. For instance, the bench system may include additional components or accessories to facilitate the operation, maintenance, or use of the mass spectrometer and the pump. These additional components or accessories may be integrated with the bench, the pump assembly, the lift mechanism, or any other part of the bench system.

In some cases, the bench system may include a control system or user interface for controlling the operation of the lift mechanism, the pump, or the mass spectrometer. The control system or user interface may include various input devices, such as buttons, switches, touch screens, or the like, and may also include various output devices, such as displays, indicators, or the like. The control system or user interface may be configured to provide feedback to a user regarding the status or operation of the lift mechanism, the pump, or the mass spectrometer.

In some aspects, the bench system may include a power supply for providing power to the lift mechanism, the pump, the mass spectrometer, or any other powered components of the bench system. The power supply may be integrated with the bench, the pump assembly, the lift mechanism, or any other part of the bench system. The power supply may include various types of power sources, such as batteries, power cords, power adapters, or the like.

In some cases, the bench system may include various safety features or mechanisms to protect the mass spectrometer, the pump, or other components of the bench system from damage or malfunction. These safety features or mechanisms may include, for example, overload protection mechanisms, temperature sensors, vibration sensors, or the like. For instance, based on sensor feedback (e.g., temperature greater than temperature threshold, vibration greater than vibration threshold, current draw greater than current threshold), the bench system may perform defined actions. As an example, in some cases, the bench system may include a fan to circulate/expel hot air from inside the bench system (e.g., when the bench system includes a compartment below the bench 902 that is enclosed by panels/doors). The bench system may turn on the fan when (or in response to) the sensed temperature being greater than the temperature threshold, thereby cooling down the compartment with the pump 906A and avoiding damage to pump 906A (or other systems).

In some aspects, the bench system may be configured to accommodate different types or models of mass spectrometers or pumps. For instance, the bench, the pump assembly, the lift mechanism, or any other part of the bench system may be adjustable or modular to fit different sizes or shapes of mass spectrometers or pumps.

In some cases, the bench system may be made from various materials to provide desired properties, such as strength, durability, weight, cost, or the like. The materials may include, for example, metals, plastics, composites, or the like. The bench system may also include various finishes or coatings to provide desired aesthetic or functional properties, such as color, texture, corrosion resistance, or the like.

In some aspects, the bench system may be designed or configured for specific applications or environments. For instance, the bench system may be designed for use in laboratories, factories, hospitals, or other settings where mass spectrometers are used. The bench system may also be designed to meet specific regulatory or industry standards or requirements.

### 3. Terminology

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

### 4. Examples

Exemplary embodiments of the systems and methods disclosed herein are described in the numbered paragraphs below:

A1. A bench system, comprising:
a bench configured to support a mass spectrometer;
a pump assembly configured to support a pump, wherein the pump assembly has legs and feet for resting on a floor; and
a lift mechanism, wherein the lift mechanism is configured to move the pump assembly between a first state and a second state,
wherein, in the first state, the pump assembly is at rest on a floor, thereby isolating the mass spectrometer from vibrations caused by the pump when the pump is in operation, and,
   in the second state, the pump assembly is moved off the floor, thereby enabling the bench system to be moved.

A2. The bench system of A1, wherein the lift mechanism includes a jack screw gear box, an electrical linear actuator, or a mechanical lifting lever.

A3. The bench system of any of A1-A2, wherein the lift mechanism is driven manually or electronically by a motor.

A4. The bench system of any of A1-A3, wherein the pump assembly includes a drawer and rail system configured to slide the pump in and out for maintenance and/or removal.

A5. The bench system of any of A1-A4, wherein the lift mechanism includes a load shaft and a load shaft flange.

A6. The bench system of any of A1-A5, wherein the pump assembly includes brackets positioned to allow the load shaft flange to lift the pump assembly when the load shaft is raised.

A7. The bench system of any of A1-A6, wherein the pump assembly includes a cylinder with a counter bore configured to lift the pump assembly.

A8. The bench system of any of A1-A7, wherein the load shaft flange has holes, and the pump assembly has shoulder screws that interact with the holes that enable the pump assembly to be lifted.

A9. The bench system of any of A1-A8, wherein the lift mechanism is connected to a cable that connects to the pump assembly, and the cable is configured to lift the pump assembly.

A10. The bench system of any of A1-A9, wherein the bench system includes wheels configured to move the bench system.

A11. The bench system of any of A1-A10, wherein the bench system includes a hose and one or more wall panels, the hose connects the pump and the mass spectrometer, and a first wall panel of the one or more wall panels includes an opening to pass the hose between the pump and the mass spectrometer.

A12. The bench system of any of A1-A11, wherein the pump assembly has pump assembly legs to engage the floor.

A13. The bench system of A12, wherein the pump assembly legs include feet made of a vibration-damping material.

A14. The bench system of any of A1-A13, wherein the bench system includes a floor panel with one or more openings to allow the pump assembly legs to pass through without engaging the floor panel.

A15. The bench system of any of A1-A14, wherein the lift mechanism is connected to an actuator configured to facilitate the transition of the pump assembly between the first state and the second state.

A16. The bench system of any of A1-A15, wherein the bench system includes a control system for controlling operation of the lift mechanism.

A17. The bench system of any of A1-A16, wherein the bench system includes a power supply configured to power the pump assembly, the lift mechanism, and/or the mass spectrometer.

A18. A method for isolating a mass spectrometer from vibrations caused by a pump, the method comprising:
providing a bench system to support a mass spectrometer, wherein the bench system includes: a bench for supporting the mass spectrometer, a pump assembly for supporting a pump, and a lift mechanism, and the lift mechanism is configured to move the pump assembly between a first state and a second state;
resting, in the first state, the pump assembly on a floor, thereby isolating the mass spectrometer from vibrations caused by the pump when the pump and the mass spectrometer are in use;
moving, by the lift mechanism, the pump assembly from the first state to the second state, thereby enabling the bench system to be moved;
moving, by the lift mechanism, the pump assembly from the second state to the first state.

A19. The method of A18, wherein the lift mechanism includes a jack screw gear box, an electrical linear actuator, or a mechanical lifting lever, and wherein the moving of the pump assembly is facilitated by one of these components.

A20. The method of any of A18-A19, wherein the pump assembly includes a drawer and rail system, and wherein the pump is slid in and out for maintenance and/or removal as part of the moving step.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A bench system, comprising:
a bench configured to support a mass spectrometer;
a pump assembly configured to support a pump, wherein the pump assembly has legs and feet for resting on a floor; and
a lift mechanism, wherein the lift mechanism is configured to move the pump assembly between a first state and a second state,
wherein, in the first state, the pump assembly is at rest on a floor, thereby isolating the mass spectrometer from vibrations caused by the pump when the pump is in operation, and,
in the second state, the pump assembly is moved off the floor, thereby enabling the bench system to be moved.

2. The bench system of claim 1, wherein the lift mechanism includes a jack screw gear box, an electrical linear actuator, or a mechanical lifting lever.

3. The bench system of claim 1, wherein the lift mechanism is driven manually or electronically by a motor.

4. The bench system of claim 1, wherein the pump assembly includes a drawer and rail system configured to slide the pump in and out for maintenance and/or removal.

5. The bench system of claim 1, wherein the lift mechanism includes a load shaft and a load shaft flange.

6. The bench system of claim 5, wherein the pump assembly includes brackets positioned to allow the load shaft flange to lift the pump assembly when the load shaft is raised.

7. The bench system of claim 1, wherein the pump assembly includes a cylinder with a counter bore configured to lift the pump assembly.

8. The bench system of claim 1, wherein the load shaft flange has holes, and the pump assembly has shoulder screws that interact with the holes that enable the pump assembly to be lifted.

9. The bench system of claim 1, wherein the lift mechanism is connected to a cable that connects to the pump assembly, and the cable is configured to lift the pump assembly.

10. The bench system of claim 1, wherein the bench system includes wheels configured to move the bench system.

11. The bench system of claim 1, wherein the bench system includes a hose and one or more wall panels, the hose connects the pump and the mass spectrometer, and a first wall panel of the one or more wall panels includes an opening to pass the hose between the pump and the mass spectrometer.

12. The bench system of claim 1, wherein the pump assembly has pump assembly legs to engage the floor.

13. The bench system of claim 12, wherein the pump assembly legs include feet made of a vibration-damping material.

14. The bench system of claim 1, wherein the bench system includes a floor panel with one or more openings to allow the pump assembly legs to pass through without engaging the floor panel.

15. The bench system of claim 1, wherein the lift mechanism is connected to an actuator configured to facilitate the transition of the pump assembly between the first state and the second state.

16. The bench system of claim 1, wherein the bench system includes a control system for controlling operation of the lift mechanism.

17. The bench system of claim 1, wherein the bench system includes a power supply configured to power the pump assembly, the lift mechanism, and/or the mass spectrometer.

18. A method for isolating a mass spectrometer from vibrations caused by a pump, the method comprising:
providing a bench system to support a mass spectrometer, wherein the bench system includes: a bench for supporting the mass spectrometer, a pump assembly for supporting a pump, and a lift mechanism, and the lift mechanism is configured to move the pump assembly between a first state and a second state;
resting, in the first state, the pump assembly on a floor, thereby isolating the mass spectrometer from vibrations caused by the pump when the pump and the mass spectrometer are in use;
moving, by the lift mechanism, the pump assembly from the first state to the second state, thereby enabling the bench system to be moved;
moving, by the lift mechanism, the pump assembly from the second state to the first state.

19. The method of claim 18, wherein the lift mechanism includes a jack screw gear box, an electrical linear actuator, or a mechanical lifting lever, and wherein the moving of the pump assembly is facilitated by one of these components.

20. The method of claim 18, wherein the pump assembly includes a drawer and rail system, and wherein the pump is slid in and out for maintenance and/or removal as part of the moving step.
